(19) United States
(12) Patent Application Publication
(10) Pub. No.: US 2025/0234913 A1
(43) Pub. Date: Jul. 24, 2025

(54) FRUIT PRESS FOR FRUITS WITH A PEEL

(71) Applicant: Citrocasa GmbH, Linz (AT)

(72) Inventor: Johannes Huber, Luftenberg (AT)

(21) Appl. No.: 18/970,915

(22) Filed: Dec. 6, 2024

(30) Foreign Application Priority Data
Jan. 18, 2024 (AT) A50030/2024

(51) Int. Cl. A23N 1/00; A47J 19/02

(52) U.S. Cl. CPC A23N 1/003; A47J 19/02

(57) ABSTRACT

A fruit press for fruits with a peel has two press rollers arranged on either side of a blade, drivable in opposite directions and forming press recesses distributed over the circumference of the press rollers, and having two ram heads-beneath the press rollers and drivable in opposite directions to the press rollers. The ram heads carry press rams distributed over the circumference of the ram heads that interact with the press recesses of the press rollers. The press recesses have, in a center plane perpendicular to the axis of rotation of their press roller, a center cross-section in the form of a circular sector with a rounded vertex region between the two radials delimiting the circular sector. The press rams of the ram heads have, in a projection parallel to the axis of rotation of the ram heads, a contour that follows the center cross-section of the press recesses at a distance.

The invention relates to a fruit press for fruits with a peel with two press rollers arranged on either side of a blade, drivable in opposite directions and forming press recesses distributed over the circumference of the press rollers, and with two ram heads provided below the press rollers and drivable in opposite directions to the press rollers, which ram heads carry press rams distributed over the circumference and interacting with the press recesses of the press rollers.

In known fruit presses of this type (U.S. Pat. No. 5,170,699 A, WO 2004/052126 A1), the fruits with a peel to be pressed out, in particular oranges, are conveyed into the gusset area between the press rollers, where they are halved with the help of a blade engaging between the press rollers from below in order to receive the fruit halves in hemispherical press recesses of the press rollers. The ram heads, which interact with the press rollers and are arranged below the press rollers, have spherical press rams, which engage in the press recesses of the press rollers when the press rollers and ram heads are driven and thereby press out the fruit halves. The diameters of the usually four hemispherical press recesses determine, on the one hand, the diameter of the press rollers and, on the other hand, the maximum nominal diameter of the fruits with a peel to be pressed out. In order to be able to press out larger fruits with a peel, larger press rollers and therefore an adapted size of the fruit press are required.

To reduce the size, it is known (AT 508 946 A1) to arrange the shafts of the press rollers on the one hand and the shafts of the associated ram heads, each having two diametrically opposed press rams, on the other in common, parallel axial planes, but this does not help to increase the diameter range of the fruits with a peel that can be pressed out with the fruit press.

In order to be able to press citrus fruits in a larger diameter range, it has already been proposed (AT 521 141 A1) to provide two pressing units with different diameters of the press recesses and of the press rams interacting with the press recesses on common shafts and to place a sorting device for the citrus fruits upstream of these two pressing units, so that the citrus fruits are fed to the two pressing units sorted by size. A disadvantage, however, is the increased design complexity due to the two pressing units and the sorting device.

In fruit presses in which the pressing tools holding the fruit halves in press recesses are pressed in a vertical direction onto stationary press rams, it is known (US 2022175010 A1) that the pressing tools and press rams can be exchanged to adapt to different pressed fruits and that the pressing stroke associated with the tool change can be adapted by controlling a motor provided separately for the pressing stroke.

Finally, it is known (CN 106490952 A) to adapt the gap between the press recesses and the press rams engaging in the press recesses to the peel thickness by changing the distance between the shafts for the press rollers with the press recesses on the one hand and the shafts for the press rams on the other, which is not only associated with additional design effort for changing the distance between the shafts, but also makes handling difficult because the shaft distance must be adjusted depending on the peel thickness.

The invention is thus based on the task of creating a fruit press with the aid of which the maximum nominal size of the fruits with a peel to be pressed out can be increased without having to change the size of the fruit press.

Based on a fruit press of the type described at the beginning, the invention solves the problem set by the fact that the press recesses have a center cross-section in the form of a circular sector with a rounded vertex region between the two radii delimiting the circular sector in a center plane perpendicular to the axis of rotation of their press roller and the press rams of the ram heads have a contour following the center cross-section of the press recesses at a distance in a projection parallel to the axis of rotation of the ram heads.

As a result of this measure, the circumferential length of the center cross-section of the press recesses and thus, due to the continuous course of the surface of the press recesses, also the circumferential lengths of the cross-sections of the press recesses parallel to the center cross-section are larger in comparison with corresponding cross-sections of hemispherical press recesses with the same base area determined by the opening width. Due to the larger surface area compared to hemispherical press recesses, press rollers with press recesses according to the invention can accommodate larger fruits with a peel without having to change the size of the press rollers. By adapting the press rams of the ram heads to the shape of the press recesses, the surface of the ram heads follows the surface of the press recesses at a distance dependent on a predetermined nominal shell thickness of the peel fruits as a prerequisite for good juicing of the fruits with a peel.

Since the proposed measure of changing the cross-section of the press recesses perpendicular to the axis of rotation of the press roller compared to a circular shape is independent of the base area of the press recesses determined by the opening width of the press recesses, in contrast to conventional circular base areas, the base areas of the press recesses according to the invention can have a larger diameter in the direction of the axes of the press roller than transversely thereto, whereby the surface of the press recesses can be additionally enlarged without having to enlarge the press rollers, in particular with regard to their diameter.

The subject of the invention is shown in the drawing, for example, wherein

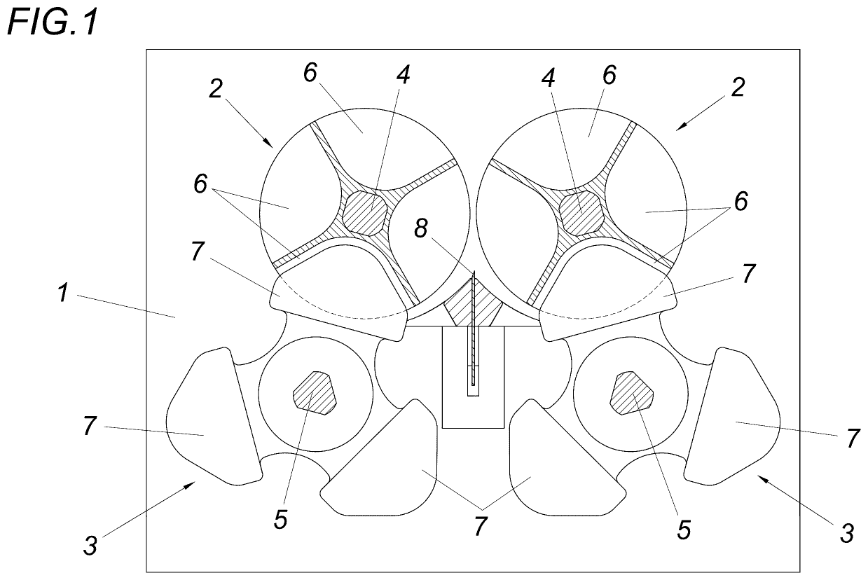

FIG. 1 shows a sectional view of a fruit press according to the invention in the area of the interacting press rollers and ram heads in a schematic section perpendicular to the axes of rotation of the press rollers and ram heads,

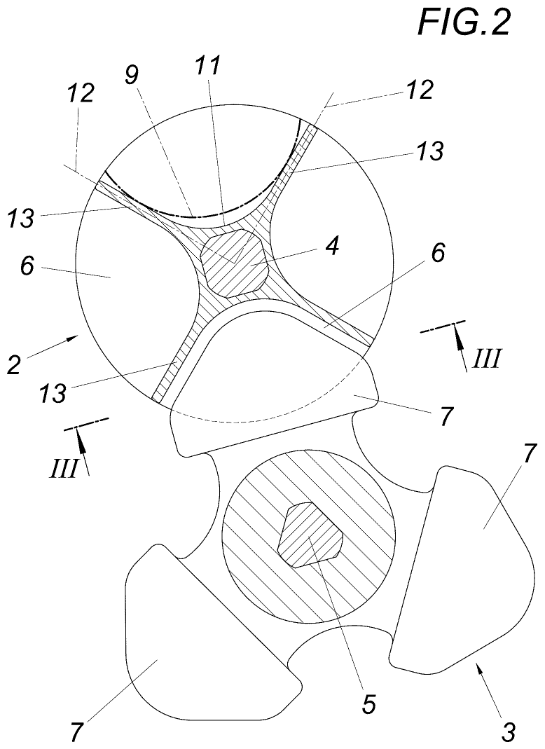

FIG. 2 shows a press roller and a ram head cooperating with the press roller in an engagement position on a larger scale and

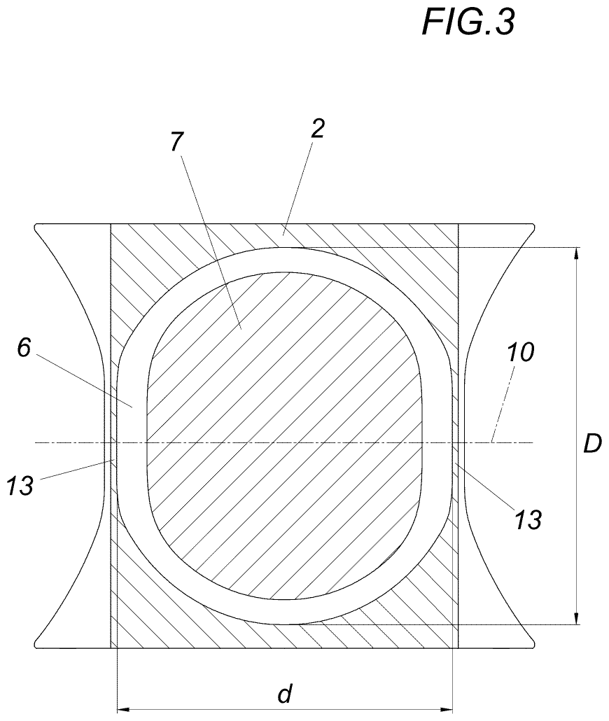

FIG. 3 shows a section along line III-III of FIG. 2.

A fruit press according to the invention conventionally has a frame 1 in which two press rollers 2 and, below these press rollers 2, two ram heads 3 interacting with the press rollers 2 are mounted on parallel shafts 4 and 5. The press rollers 2 are provided with press recesses 6, which interact with press rams 7 of the ram heads 3. A blade is arranged in the gusset area between the press rollers 2, which is acted upon for the cutting stroke by means of driving cams assigned to the ram heads 3, which driving cams are not shown for reasons of clarity. The fruits with a peel to be pressed out, in particular oranges, are conveyed from above into the gusset area between the press rollers 2 via a feed channel not shown and are picked up by the press recesses 6 of the press rollers 2 in order to be conveyed downwards against the blade 8, which is raised by the driver cams. Since the press rams 7 of the ram heads 3 penetrate the press recesses 6 as the press rollers 2 continue to rotate, the fruit halves picked up by the press recesses 6 are pressed out by the press rams 7. The remaining peel halves with the fruit residues adhere to the press rams 7 and are discharged from the press recesses 6 of the press rollers 2 by the press rams 7 and then stripped from the press rams 7.

As can be seen in the schematic representation according to FIG. 2, in contrast to press rollers with conventional hemispherical press recesses 9 indicated by dotted lines, the press rollers 2 according to the invention have press recesses 6 which, in a center plane perpendicular to the axis of rotation of the press roller 2 and designated 10 in FIG. 3 have a center cross-section in the form of a circular sector with a rounded vertex region 11 between the two radials 12 delimiting the circular sector, so that the radial partitions 13 between the press recesses 6 in the region of the center plane 10 up to the rounded vertex region 11 are of uniform thickness.

By comparing the center cross-sections of a press recess 6 according to the invention and a conventional hemispherical press recess 9, it is immediately apparent from FIG. 2 that the center cross-section of the press recess 6 according to the invention has a larger circumferential length than the center cross-section of a hemispherical press recess 9. Due to the necessarily continuous course of the surface of the press recesses 6, also in the direction of the axis of the press roller 2, a larger circumferential length also follows for cross-sections parallel to the center plane, so that press rollers 2 according to the invention can accommodate fruits with a peel with a larger nominal diameter than conventional press rollers due to the larger surface and thus the larger volume of the press recesses 6.

Since the press rams 7 of the ram heads 3 in a projection parallel to the axis of rotation of the ram heads 3 have a contour that follows the center cross-section of the press recesses 6 at a distance, as illustrated in FIG. 2, and also have a surface shape in the remaining area that follows the surface of the press recesses 6 at a predetermined distance, approved juicing conditions result.

In order to additionally increase the surface area and the volume of the press recesses 6, they can be widened in the direction of the axis of the press rollers 2, so that the base areas of the press recesses 6 formed by the opening of the press recesses 6 according to FIG. 3 have a larger diameter D in the direction of the roller axis than the diameter d extending transversely thereto. The correspondingly adapted press rams 7 are therefore provided with a base, the base areas of which in turn have a larger diameter in the direction of the axis of rotation of the ram head 3 than transversely thereto.

1. A fruit press for fruits with a peel, said fruit press comprising:
a blade having two opposing sides;
two press rollers, each of the press rollers being arranged on a respective side of the blade, said press rollers being driven to rotate in opposite directions relative to each other, and the press rollers having press recesses distributed over circumference thereof; and
two ram heads supported beneath the press rollers and each being driven to rotate in a respective direction opposite relative to a respective one of the press rollers,
wherein the ram heads carry press rams that are distributed over a circumference of the associated ram head heads and that interact with the press recesses of the press rollers;
wherein the press recesses have, in a center plane perpendicular to an axis of rotation of the associated press roller, a center cross-section in a form of a circular sector with a rounded vertex region between two radials delimiting the circular sector; and
wherein the press rams of the ram heads each have, in a projection parallel to a respective axis of rotation of the associated ram head, a contour that follows the center cross-section of one of the press recesses spaced at a distance therefrom.

2. A fruit press according to claim 1, wherein the press recesses have base areas defined by openings of the press recesses, and the press rams have base areas each formed by a respective base of the press rams, wherein the base areas each have a first diameter in a direction of the axis of rotation of the associated press roller or the associated press ram, and a second diameter in a direction extending transversely to said axis of rotation, said first diameter being larger than said second diameter.
